(19) United States
(12) Patent Application Publication
(10) Pub. No.: US 2022/0206888 A1
(43) Pub. Date: Jun. 30, 2022

(54) ABNORMAL PORTION DETECTING DEVICE, METHOD OF DETECTING ABNORMAL PORTION, AND RECORDING MEDIUM

(71) Applicant: Mitsubishi Electric Corporation, Tokyo (JP)

(72) Inventors: Osamu NASU, Tokyo (JP); Yu KABASAWA, Nagoya-shi, Aichi (JP)

(73) Assignee: Mitsubishi Electric Corporation, Tokyo (JP)

(21) Appl. No.: 17/625,342

(22) PCT Filed: Aug. 28, 2019
(86) PCT No.: PCT/JP2019/033716

§ 371 Date: Jan. 7, 2022

(51) Int. Cl. G06F 11/07; G06N 3/08

(52) U.S. Cl. CPC G06F 11/079; G06N 3/08; G06F 11/0736

(57) ABSTRACT

An abnormal portion detecting device (10) includes a determiner (101) to determine whether received data contains any abnormality, a diagnostic target data transmitter (102) to transmit diagnostic target data to the determiner (101), a modification target portion determiner (103) to determine a modification target portion in the diagnostic target data determined to contain an abnormality by the determiner (101), a modifier (104) to modify the modification target portion in the diagnostic target data and generate modified data, a modified data transmitter (105) to transmit the modified data to the determiner (101), and an abnormal portion detector (106) to detect the modification target portion determined by the modification target portion determiner (103) as an abnormal portion in the diagnostic target data when the determiner (101) determines that the modified data contains no abnormality.

### TECHNICAL FIELD

The present disclosure relates to an abnormal portion detecting device, a method of detecting an abnormal portion, and a program.

### BACKGROUND ART

Some techniques have been known that involve acquiring and analyzing data on a machine and determining whether the data contains any abnormality. These techniques are aimed at diagnosis of data on a machine, and this data is thus hereinafter referred to as “diagnostic target data”. The determination of existence of an abnormality in the diagnostic target data can achieve detection of whether any abnormality occurs in the machine, for example.

For example, Patent Literature 1 discloses a technique that involves diagnosing diagnostic target data acquired from an acceleration sensor provided to a mold oscillator through frequency analysis of the diagnostic target data, and detecting whether any abnormal oscillation occurs in the mold.

### CITATION LIST

### Patent Literature

Patent Literature 1: Unexamined Japanese Patent Application Publication No. H07-214265

### SUMMARY OF INVENTION

### Technical Problem

If not only determination of existence of an abnormality in the diagnostic target data but also detection of a portion (hereinafter referred to as “abnormal portion”) in the diagnostic target data that causes the abnormality can be achieved, the cause of the abnormality is expected to be more readily specified.

The technique disclosed in Patent Literature 1 involves executing frequency analysis of diagnostic target data and outputting a result of analysis of the diagnostic target data using a neural network. Unfortunately, the result of analysis in this technique is any of the values (appropriate, high, and low values) equal to the input values provided during preliminary learning. Although checking of the contents of operations in the neural network is available, formulation of an input value that significantly affects the result of analysis cannot be readily achieved. That is, the technique disclosed in Patent Literature 1 can detect whether an abnormality exists but cannot readily detect a portion in the diagnostic target data that corresponds to an abnormal portion in the case of determination of an abnormality.

An objective of the present disclosure, which has been accomplished in view of the above situations, is to provide an abnormal portion detecting device and the like that can detect an abnormal portion in diagnostic target data.

### Solution to Problem

In order to achieve the above objective, an abnormal portion detecting device according to an aspect of the present disclosure includes: determination means for determining whether received data contains any abnormality; diagnostic-target-data transmission means for transmitting diagnostic target data to the determination means; modification-target-portion determination means for determining a modification target portion in the diagnostic target data determined to contain an abnormality by the determination means; modification means for modifying the modification target portion in the diagnostic target data and generating modified data; modified data transmission means for transmitting the modified data to the determination means; and abnormal portion detection means for detecting the modification target portion determined by the modification-target-portion determination means as an abnormal portion in the diagnostic target data when the determination means determines that the modified data contains no abnormality.

### Advantageous Effects of Invention

According to an aspect of the present disclosure, when the diagnostic target data is determined to contain an abnormality and the modified data is determined to contain no abnormality, the modification target portion is detected as an abnormal portion in the diagnostic target data. The present disclosure can thus achieve detection of an abnormal portion in the diagnostic target data.

### BRIEF DESCRIPTION OF DRAWINGS

FIG. 1 illustrates a functional configuration of an abnormal portion detecting device according to Embodiment 1 of the present disclosure;

FIG. 2 illustrates an example of diagnostic target data according to Embodiment 1 of the present disclosure;

FIG. 3 illustrates construction of a normal data model according to Embodiment 1 of the present disclosure;

FIG. 4 illustrates an example of a masking process according to Embodiment 1 of the present disclosure;

FIG. 5 illustrates another example of a masking process according to Embodiment 1 of the present disclosure;

FIG. 6 illustrates an exemplary hardware configuration of the abnormal portion detecting device according to Embodiment 1 of the present disclosure;

FIG. 7 is a flowchart illustrating an exemplary operation of data diagnosis according to Embodiment 1 of the present disclosure;

FIG. 8 is a flowchart illustrating an exemplary operation of abnormal portion detection according to Embodiment 1 of the present disclosure;

FIG. 9 illustrates a functional configuration of an abnormal portion detecting device according to Embodiment 2 of the present disclosure;

FIG. 10 illustrates an example of a replacement process according to Embodiment 2 of the present disclosure;

FIG. 11 illustrates construction of a normal data model and a replacement data model according to Embodiment 2 of the present disclosure;

FIG. 12 illustrates exemplary pairs of a replacement target portion and non-replacement-target portions according to Embodiment 2 of the present disclosure;

FIG. 13 illustrates a functional configuration of an abnormal portion detecting device according to Embodiment 3 of the present disclosure;

FIG. 14 is a flowchart illustrating an exemplary operation of data diagnosis according to Embodiment 3 of the present disclosure;

FIG. 15 illustrates an example of a masking process to thermal image data according to a modification of the embodiments of the present disclosure;

FIG. 16 illustrates an example of a masking process according to a modification of the embodiments of the present disclosure;

FIG. 17 illustrates another example of a masking process according to a modification of the embodiments of the present disclosure; and

FIG. 18 illustrates an example in which a masking target portion has a width narrower than the width of an abnormal portion according to Embodiment 1 of the present disclosure.

### DESCRIPTION OF EMBODIMENTS

An abnormal portion detecting device according to embodiments of the present disclosure is described below with reference to the accompanying drawings. In these drawings, the components identical or corresponding to each other are provided with the same reference symbol.

### Embodiment 1

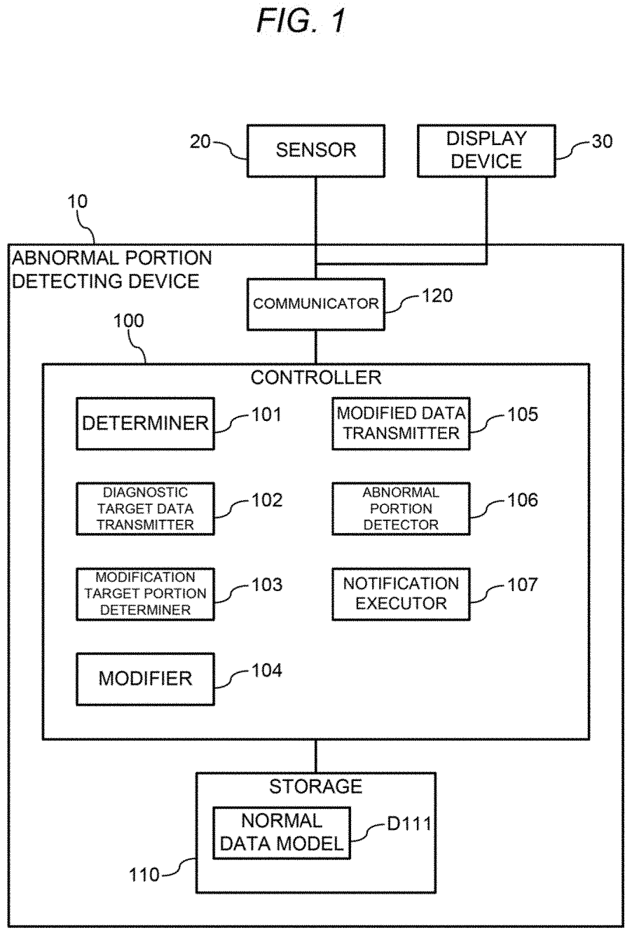

An abnormal portion detecting device 10 according to Embodiment 1 is described below with reference to FIG. 1. The abnormal portion detecting device 10 diagnoses data acquired from the sensor 20 as diagnostic target data. When the diagnostic target data contains any abnormality, the abnormal portion detecting device 10 causes a display device 30 to display information indicating an abnormality existing in the diagnostic target data, and information indicating a portion (hereinafter referred to as “abnormal portion”) in the diagnostic target data that causes the abnormality, and thereby notifies a user of the information. The abnormal portion detecting device 10 is an example of an abnormal portion detecting device according to the present disclosure.

The sensor 20 is, for example, a temperature sensor, a voltage sensor, or an acceleration sensor. The sensor 20 is provided to a machine tool installed in a production site, for example. The sensor 20 continuously transmits data indicating a detected temperature, voltage, or acceleration, for example, to the abnormal portion detecting device 10.

In general, the machine tool continuously executes a predetermined operation. The data transmitted from the sensor 20 provided to the machine tool is therefore expected to vary in a regular manner unless any abnormality occurs in the machine tool. In contrast, when any abnormality occurs in the machine tool, the data transmitted from the sensor 20 is highly likely to contain an abnormal variation.

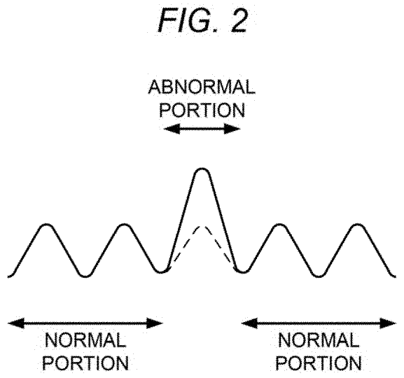

The following description assumes an exemplary case where the data transmitted from the sensor 20 is chronological data as illustrated in FIG. 2. The dashed-line segment indicates a normal variation within an abnormal portion, which is described below. In FIG. 2, the segments represented as “normal portion” have a relatively small amplitude and show a periodic variation. In contrast, the segment represented as “abnormal portion” varies more significantly and suddenly than the segments represented as “normal portion”. This data therefore has to be diagnosed to contain an abnormality because of the segment represented as “abnormal portion”. The following description also assumes that the diagnostic target data is the data illustrated in FIG. 2 unless otherwise specified.

Referring back to FIG. 1, the display device 30 includes a liquid crystal display, for example. The display device 30 receives an image signal from the abnormal portion detecting device 10 and displays an image on the basis of the image signal.

A functional configuration of the abnormal portion detecting device 10 is described below. The abnormal portion detecting device 10 includes a controller 100, a storage 110, and a communicator 120.

The controller 100 performs comprehensive control of the abnormal portion detecting device 10. The controller 100 includes a determiner 101, a diagnostic target data transmitter 102, a modification target portion determiner 103, a modifier 104, a modified data transmitter 105, an abnormal portion detector 106, and a notification executor 107.

The determiner 101 receives data from the diagnostic target data transmitter 102 and the modified data transmitter 105, and determines whether the received data contains any abnormality. The determiner 101 determines existence of an abnormality in the received data on the basis of a normal data model D111, which is described below, stored in the storage 110. The details of the normal data model D111 and the details of the determination are described below. The determiner 101 is an example of determination means according to the present disclosure.

The diagnostic target data transmitter 102 continuously acquires data from the sensor 20 via the communicator 120, accumulates the data for a certain period, and transmits the accumulated data to the determiner 101 as the diagnostic target data. Examples of the “certain period” include ten seconds and one minute. The diagnostic target data transmitter 102 is an example of diagnostic-target-data transmission means according to the present disclosure.

When the determiner 101 determines that the diagnostic target data contains any abnormality, the modification target portion determiner 103 determines a modification target portion to be modified in the diagnostic target data. The details of the determination of the modification target portion are described below. The modification target portion is determined a plurality of times, which is described in detail below. The modification target portion determiner 103 is an example of modification-target-portion determination means according to the present disclosure.

The modifier 104 modifies the modification target portion, determined by the modification target portion determiner 103, in the diagnostic target data, and thus generates modified data. In Embodiment 1, the modification target portion is modified by a masking process to the modification target portion, as is described below. The details of the modification are described below. The modifier 104 is an example of modification means according to the present disclosure.

The modified data transmitter 105 transmits the modified data generated by the modifier 104 to the determiner 101. The modified data transmitter 105 is an example of modified data transmission means according to the present disclosure.

When the determiner 101 determines that the modified data contains no abnormality, the abnormal portion detector 106 detects the modification target portion determined by the modification target portion determiner 103 as an abnormal portion in the diagnostic target data. When the diagnostic target data before being modified contains an abnormality and the modified data contains no abnormality, the modification is deemed to have successively removed the abnormal portion. The modification target portion therefore corresponds to the abnormal portion. The abnormal portion detector 106 is an example of abnormal portion detection means according to the present disclosure.

The notification executor 107 notifies the user of information indicating an abnormality existing in the diagnostic target data, and information indicating a portion in the diagnostic target data that corresponds to an abnormal portion. Specifically, the notification executor 107 transmits an image signal to the display device 30 via the communicator 120 and thereby notifies the user of the information.

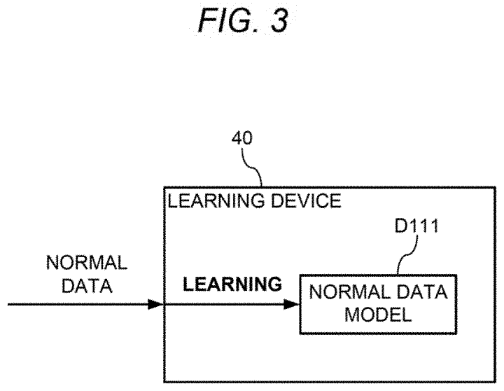

The storage 110 stores the normal data model D111. The normal data model D111 is a pre-trained model constructed through learning of normal data by a learning device 40, as illustrated in FIG. 3. The normal data indicates the data transmitted from the sensor 20 while the machine tool is continuously operating without occurrence of an abnormality, for example. FIG. 3 illustrates an example in which the normal data model D111 is constructed through unsupervised learning that involves input of only the normal data. The normal data model D111 may also be constructed through supervised learning that involves input of the normal data and abnormal data. In both cases, the normal data model D111 is a pre-trained model constructed through learning of normal data. The determiner 101 calculates a score related to the received data on the basis of the normal data model D111, for example, and thereby determines whether the received data contains any abnormality.

The learning device 40 may be separate from the abnormal portion detecting device 10, or may be integrated with the abnormal portion detecting device 10. In the case where the learning device 40 is separate from the abnormal portion detecting device 10, the normal data model D111 constructed by the learning device 40 requires to be shared with the abnormal portion detecting device 10 by any procedure. For example, the learning device 40 may be connected to the abnormal portion detecting device 10 so as to be communicable and transmits the normal data model D111 to the abnormal portion detecting device 10, thereby sharing the normal data model D111.

Referring back to FIG. 1, the communicator 120 communicates with the sensor 20 and the display device 30. In particular, the communicator 120 receives the data transmitted from the sensor 20 and transmits the image signal for notification to the display device 30.

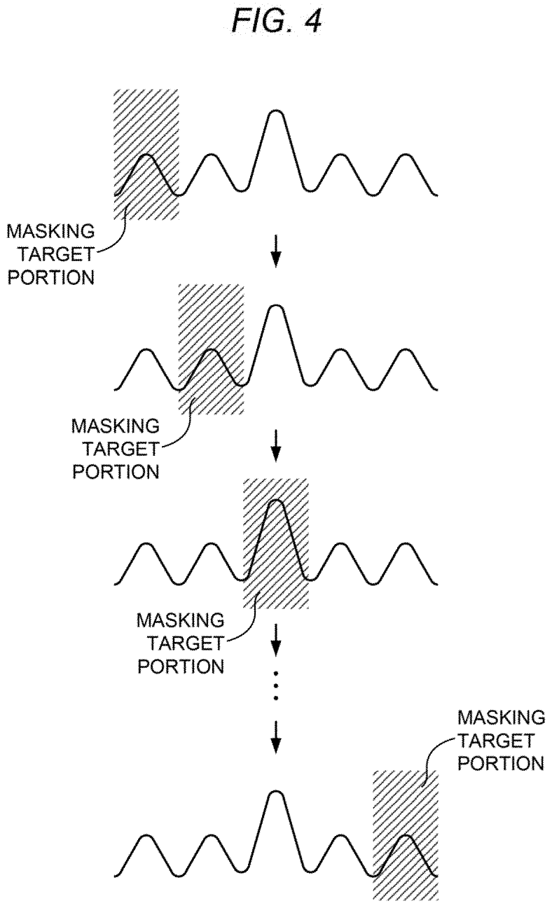

The determination of the modification target portion by the modification target portion determiner 103 and the modification by the modifier 104 are described below with reference to FIG. 4. As described above, the modification indicates a masking process in Embodiment 1. Accordingly, the determination of the modification target portion indicates the determination of a masking target portion in Embodiment 1. FIG. 4 illustrates sequential determination of a masking target portion, which is a modification target portion, in the diagnostic target data illustrated in FIG. 2, executed by the modification target portion determiner 103.

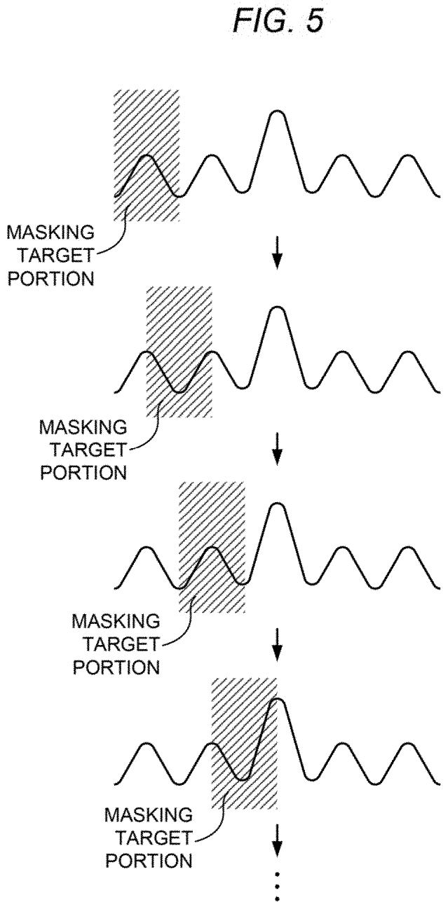

The modification target portion determiner 103 repetitively determines s modification target portion in the diagnostic target data until completion of determination of all the portions in the diagnostic target data as the modification target portion. For example, in the example illustrated in FIG. 4, the modification target portion determiner 103 shifts a masking target portion having a width of one wavelength in the diagnostic target data by a range of one wavelength from the left end to the right end. Although the width of a masking target portion and the width of shifting to the subsequent masking target portion are both one wavelength in FIG. 4 in order to facilitate an understanding, the width of a masking target portion and the width of shifting may correspond to other lengths. For example, the width of a masking target portion may be one wavelength while the width of shifting may be half of the wavelength, as illustrated in FIG. 5. That is, the modification target portions in the repeated determination may partially overlap each other.

The modifier 104 executes a masking process to the masking target portion, determined by the modification target portion determiner 103, in the diagnostic target data. The masking process excludes the masking target portion from targets of determination by the determiner 101. The following description assumes an exemplary case where the determiner 101 determines whether an abnormality exists by calculating a score related to the received data, as described above. In this case, the determiner 101 determines existence of an abnormality though calculation using the values of the received data other than the value of the masking target portion. That is, the determiner 101 determines existence of an abnormality without evaluation of data corresponding to the masking target portion.

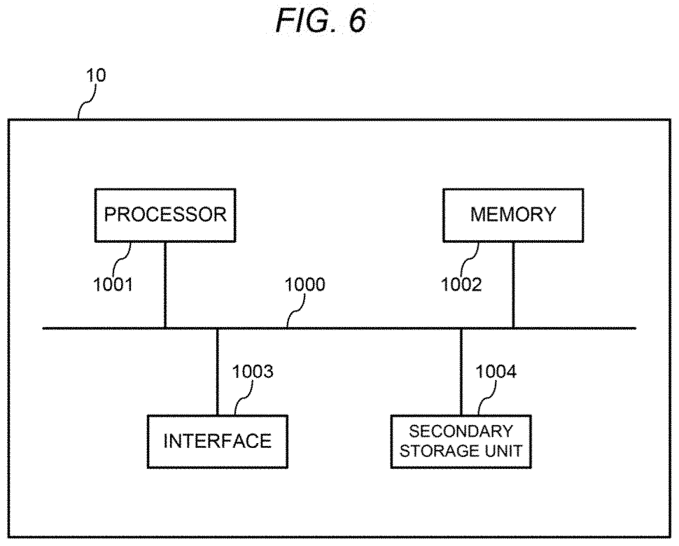

An exemplary hardware configuration of the abnormal portion detecting device 10 is described below with reference to FIG. 6. The abnormal portion detecting device 10 illustrated in FIG. 6 is achieved by a computer, such as personal computer or micro-controller, for example.

The abnormal portion detecting device 10 includes a processor 1001, a memory 1002, an interface 1003, and a secondary storage unit 1004, which are connected to each other via buses 1000.

The processor 1001 includes a central processing unit (CPU), for example. The processor 1001 loads an operational program stored in the secondary storage unit 1004 into the memory 1002 and executes the operational program, and thereby achieves the individual functions of the abnormal portion detecting device 10. The processor 1001 may include a graphics processing unit (GPU), which can achieve the functions of the determiner 101. The GPU enables the determiner 101 to achieve more rapid processing because the determiner 101 executes the processing using the pre-trained normal data model D111.

The memory 1002 is a primary storage unit including a random access memory (RAM), for example. The memory 1002 stores the operational program loaded by the processor 1001 from the secondary storage unit 1004. The memory 1002 also serves as a working memory during execution of the operational program by the processor 1001.

The interface 1003 is an input/output (I/O) interface, such as serial port, universal serial bus (USB) port, or network interface, for example. The interface 1003 can achieve the functions of the communicator 120.

The secondary storage unit 1004 is a flash memory, a hard disk drive (HDD), or a solid state drive (SSD), for example. The secondary storage unit 1004 stores the operational program to be executed by the processor 1001. The secondary storage unit 1004 can achieve the functions of the storage 110.

The same hardware configuration can be applied to an abnormal portion detecting device according to the other embodiments and modifications, which are described below.

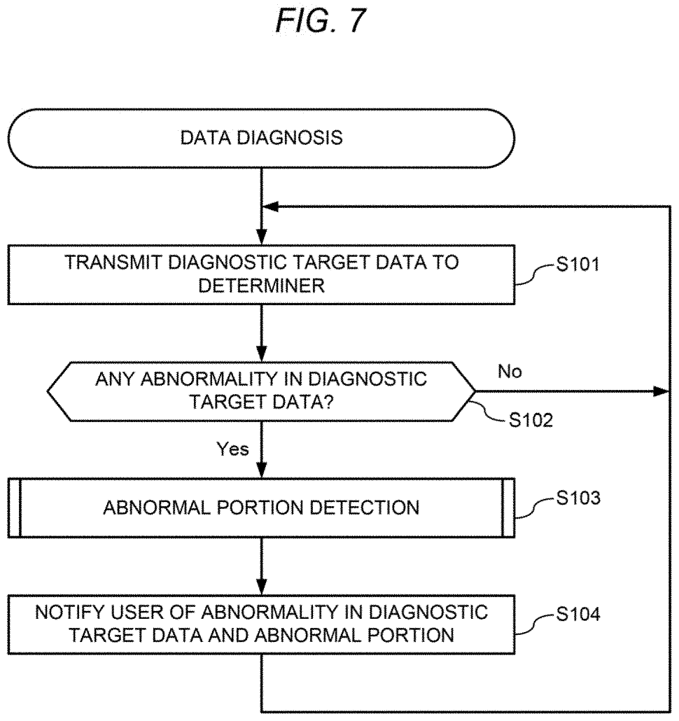

An exemplary operation of data diagnosis by the abnormal portion detecting device 10 is described below with reference to FIG. 7.

The diagnostic target data transmitter 102 of the controller 100 of the abnormal portion detecting device 10 transmits diagnostic target data to the determiner 101 of the controller 100 (Step S101). As described above, the diagnostic target data transmitter 102 continuously acquires data from the sensor 20, accumulates the data for a certain period, and transmits the accumulated data to the determiner 101 as the diagnostic target data, for example.

The determiner 101 determines whether the received diagnostic target data contains any abnormality (Step S102). When the diagnostic target data contains no abnormality (Step S102: No), the controller 100 repeats the steps from Step S101.

When the diagnostic target data contains any abnormality (Step S102: Yes), the controller 100 executes the operation of abnormal portion detection, which is described below (Step S103).

The notification executor 107 of the controller 100 notifies a user of existence of an abnormality in the diagnostic target data and of the abnormal portion detected in Step S103 (Step S104). The controller 100 then repeats the steps from Step S101.

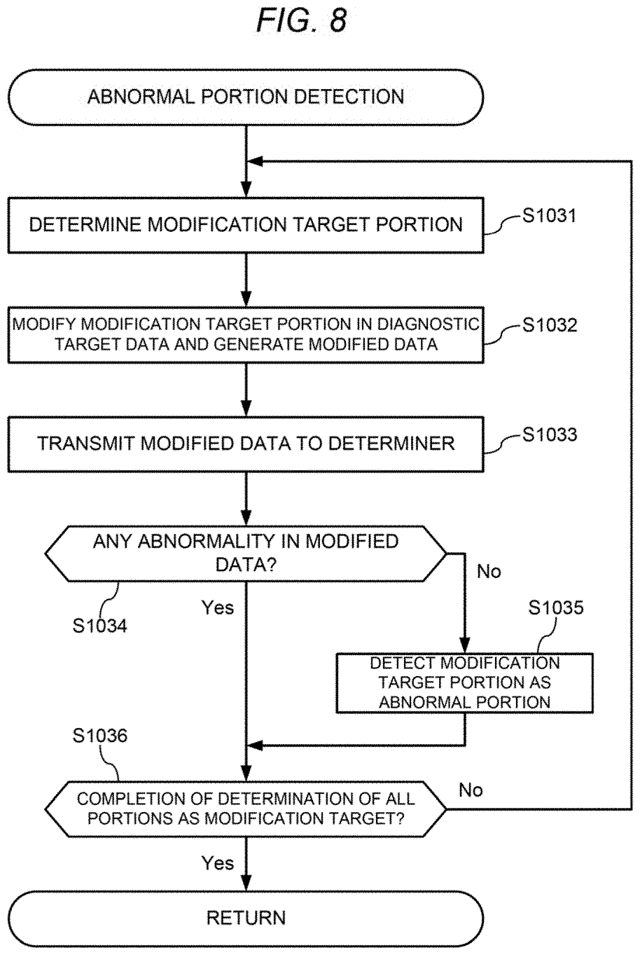

An exemplary operation of abnormal portion detection in Step S103 illustrated in FIG. 7 is described below with reference to FIG. 8.

The modification target portion determiner 103 of the controller 100 determines a modification target portion in the diagnostic target data (Step S1031). In the first execution of Step S1031, the modification target portion determiner 103 determines the portion containing the beginning of the diagnostic target data as a modification target portion. In the second and later execution of Step S1031, the modification target portion determiner 103 determines a modification target portion different from the previously determined portion. As a result, the masking target portion, which is the modification target portion, is determined as illustrated in FIG. 4 described above, for example.

The modifier 104 of the controller 100 modifies the modification target portion in the diagnostic target data determined in Step S1031 and thus generates modified data (Step S1032). As described above, the modifier 104 modifies the modification target portion by a masking process to the modification target portion in Embodiment 1.

The modified data transmitter 105 of the controller 100 transmits the modified data generated in Step S1032 to the determiner 101 (Step S1033).

The determiner 101 determines whether the received modified data contains any abnormality (Step S1034). When the modified data contains any abnormality (Step S1034: Yes), the controller 100 skips Step S1035 and proceeds to Step S1036.

When the modified data contains no abnormality (Step S1034: No), the abnormal portion detector 106 of the controller 100 detects the modification target portion as an abnormal portion in the diagnostic target data (Step S1035). The controller 100 then proceeds to Step S1036.

The controller 100 determines whether all the portions in the diagnostic target data have been determined as the modification target portion (Step S1036). When all the portions in the diagnostic target data have been determined as the modification target portion (Step S1036: Yes), the controller 100 terminates the operation of abnormal portion detection. When any portion in the diagnostic target data has not been determined as the modification target portion (Step S1036: No), the controller 100 repeats the steps from Step S1031.

The above description is directed to the abnormal portion detecting device 10 according to Embodiment 1. The abnormal portion detecting device 10 detects the modification target portion as an abnormal portion in the diagnostic target data when the diagnostic target data is determined to contain an abnormality and the modified data is determined to contain no abnormality. The abnormal portion detecting device 10 can thus detect the abnormal portion in the diagnostic target data.

### Embodiment 2

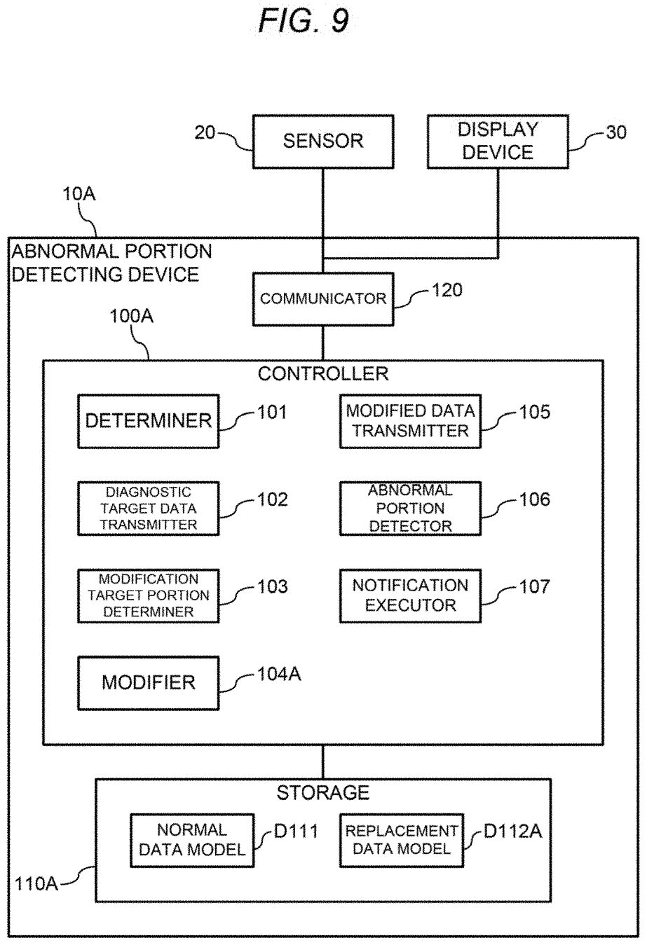

An abnormal portion detecting device 10A according to Embodiment 2 is described below with reference to FIG. 9. The abnormal portion detecting device 10A has approximately the same configuration as the abnormal portion detecting device 10 according to Embodiment 1, except for that a controller 100A and a storage 110A differ from the controller 100 and the storage 110 according to Embodiment 1.

The controller 100A differs from that in Embodiment 1 in that the controller 100A includes a modifier 104A instead of the modifier 104. The storage 110A differs from that in Embodiment 1 in that the storage 110A further stores a replacement data model D112A.

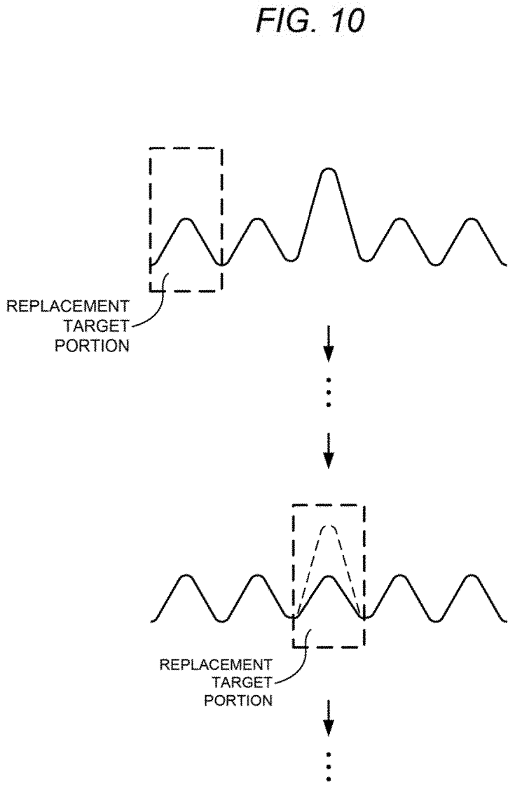

The modifier 104A differs from that in Embodiment 1 in that the modifier 104A modifies diagnostic target data by a replacement process, instead of the masking process. As illustrated in FIG. 10, the modifier 104A replaces a replacement target portion, which is a modification target portion, with normal data. In the example illustrated in FIG. 10, the diagnostic target data contains an abnormal portion at the center, which is replaced with normal data. The dashed-line segment illustrated in FIG. 10 indicates the data before being modified that corresponds to the replacement target portion. Although the replacement process is also executed to normal portions, the difference caused by the replacement process is not identified in FIG. 10 because the normal portions are expected to be substantially invariant regardless of replacement with normal data.

The modifier 104A determines normal data for use in replacement on the basis of data corresponding to non-replacement-target portions in the diagnostic target data and the replacement data model D112A.

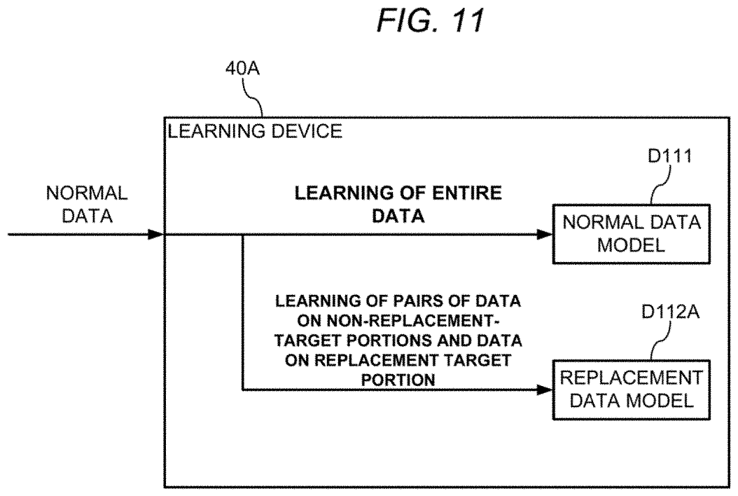

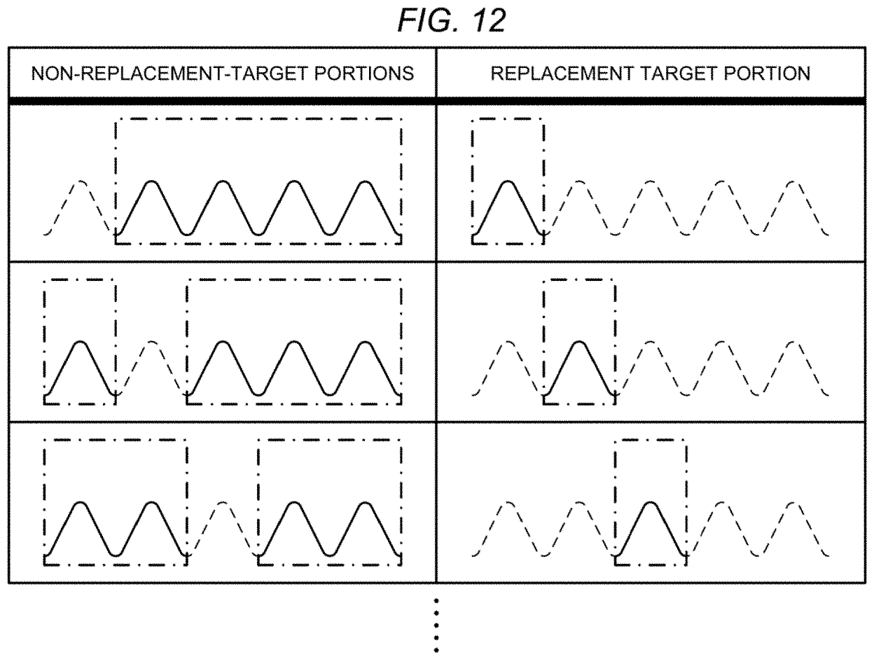

The construction of the replacement data model D112A is described below with reference to FIGS. 11 and 12. As illustrated in FIG. 11, the replacement data model D112A is constructed through input of the normal data to a learning device 40A, like the normal data model D111. As illustrated in FIG. 12, the learning device 40A learns, for each replacement target portion, a pair of the data corresponding to the non-replacement-target portions and the data corresponding to the replacement target portion.

In an exemplary case of five replacement target portions, the learning device 40A learns five pairs of data for each piece of normal data. In FIG. 12, the data surrounded by the dashed and single-dotted lines and indicated by the solid-line segments corresponds to data to be learned, while the data indicated by the dashed-line segments corresponds to data not to be learned.

The above-described construction of the replacement data model D112A leads to learning of the correspondence between the data corresponding to the non-replacement-target portions and the data corresponding to the replacement target portion in normal data, so that the modifier 104A can determine normal data for use in replacement on the basis of the data corresponding to the non-replacement-target portions in the diagnostic target data and the replacement data model D112A. Even when the data corresponding to the non-replacement-target portions in the diagnostic target data is not completely identical to the data corresponding to the non-replacement-target portions input during the learning process, the modifier 104A can determine the most appropriate normal data for use in replacement on the basis of the replacement data model D112A constructed through learning.

The operation of data diagnosis by the abnormal portion detecting device 10A is completely the same as that in Embodiment 1 except for that the replacement process is executed instead of the masking process, and therefore not redundantly described.

The above description is directed to the abnormal portion detecting device 10A according to Embodiment 2. The abnormal portion detecting device 10A can bring about the same effects as those of the abnormal portion detecting device 10 according to Embodiment 1. In addition, the abnormal portion detecting device 10A executes the replacement process with normal data instead of the masking process and, is therefore expected to improve the accuracy of determination by the determiner 101.

### Embodiment 3

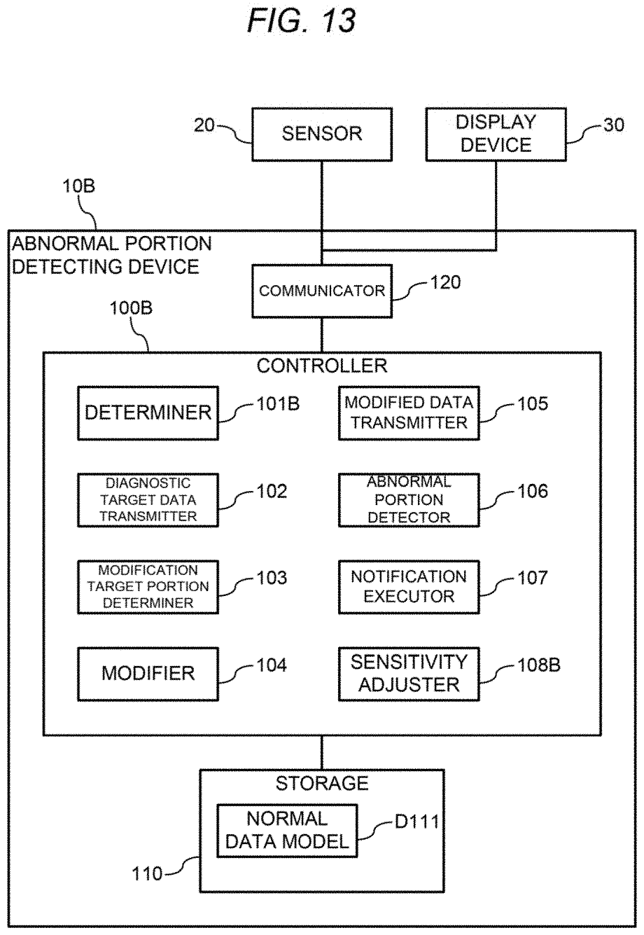

An abnormal portion detecting device 10B according to Embodiment 3 is described below with reference to FIG. 13. Embodiment 1 implicitly assumes that the diagnostic target data contains a single abnormal portion. Even in the case of a plurality of abnormal portions, the modifier 104 modifies only one of the abnormal portions. The modified data is thus always determined to contain an abnormality because of constant existence of the remaining at least one abnormal portion, which may result in unsuccessful detection of abnormal portions. Embodiment 3 deals with this problem.

The abnormal portion detecting device 10B has approximately the same configuration as the abnormal portion detecting device 10 according to Embodiment 1 except for that a controller 100B differs from the controller 100 according to Embodiment 1.

The controller 100B differs from that in Embodiment 1 in that the controller 100B includes a determiner 101B instead of the determiner 101, and further includes a sensitivity adjuster 108B.

The determiner 101B differs from the determiner 101 according to Embodiment 1 in that the sensitivity of abnormality determination by the determiner 101B can be adjusted by the sensitivity adjuster 108B. The sensitivity of abnormality determination is an index indicating a tendency to determine data to be abnormal. In an exemplary case where the determiner 101B determines an abnormality when the score resulting from score calculation is equal to or higher than a threshold, an increase in the threshold corresponds to a decrease in the sensitivity, while a decrease in the threshold corresponds to an increase in the sensitivity. On the contrary, in the case where the determiner 101B determines an abnormality when the score is equal to or smaller than a threshold, an increase in the threshold corresponds to an increase in the sensitivity, while a decrease in the threshold corresponds to a decrease in the sensitivity.

The sensitivity adjuster 108B adjusts the sensitivity of the determiner 101B such that the sensitivity during the determination in the modified data by the determiner 101B is lower than the sensitivity during the determination in the diagnostic target data. The sensitivity adjuster 108B is an example of sensitivity adjustment means according to the present disclosure.

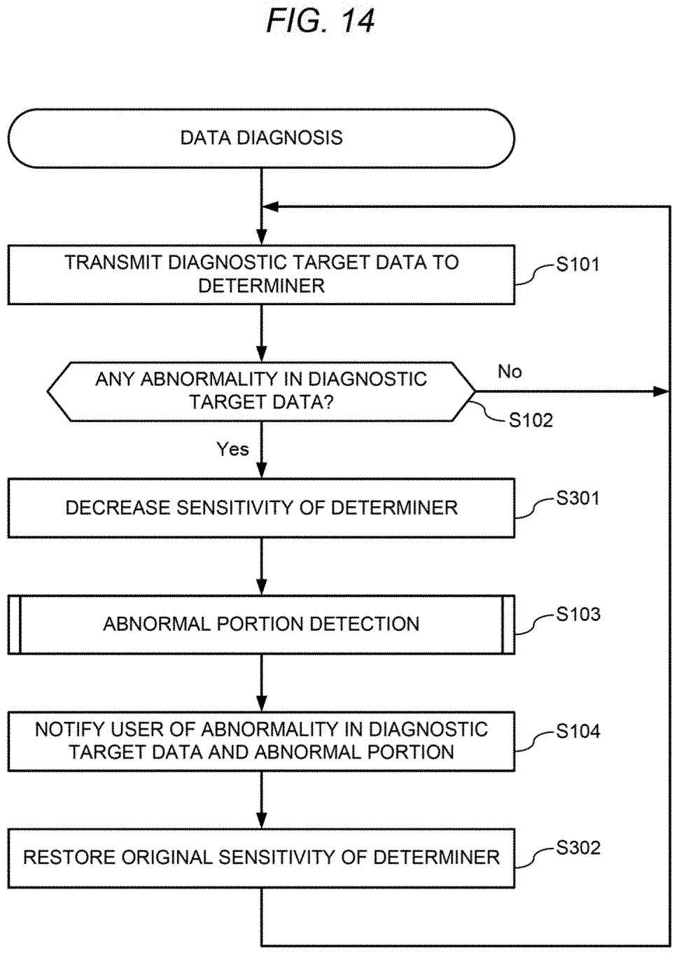

An exemplary operation of data diagnosis by the abnormal portion detecting device 10B is described below with reference to FIG. 14, focusing on the differences from the operation in Embodiment 1 illustrated in FIG. 7.

The operation illustrated in FIG. 14 is identical to that in Embodiment 1 except for that the operation further involves Step S301 between Steps S102 and S103 and Step S302 after Step S104.

The sensitivity adjuster 108B of the controller 100B of the abnormal portion detecting device 10B decreases the sensitivity of the determiner 101B (Step S301), before the operation of abnormal portion detection in Step S103. This step adjusts the sensitivity of the determiner 101B during the abnormality determination in the modified data to be lower than the sensitivity of the determiner 101B during the abnormality determination in the diagnostic target data in Step S102.

After the notification in Step S104, the sensitivity adjuster 108B restores the original sensitivity of the determiner 101B, which is decreased in Step S301 (Step S302). The controller 100B then repeats the steps from Step S101. Without this restoring step, the sensitivity remains low during the subsequent abnormality determination in the diagnostic target data. Step S302 may also be executed between Steps S103 and S104.

The above description is directed to the abnormal portion detecting device 10B according to Embodiment 3. The abnormal portion detecting device 10B can bring about the same effects as those in Embodiment 1. In addition, even in the case of a plurality of abnormal portions, as is described below, the abnormal portion detecting device 10B can detect the abnormal portions. The abnormal portion detecting device 10B adjusts the sensitivity during the determination in the modified data to be lower than the sensitivity during the determination in the diagnostic target data. Because of this adjustment, in the abnormality determination for modified data generated by modifying one of the abnormal portions existing in diagnostic target data, the abnormal portion detecting device 10B determines no abnormality despite of existence of the other abnormal portions. The abnormal portion detecting device 10B can thus detect the modification target portion as an abnormal portion.

(Modification)

The above-described Embodiment 3 is configured by applying a modification to Embodiment 1, and the same modification may also be applied to Embodiment 2.

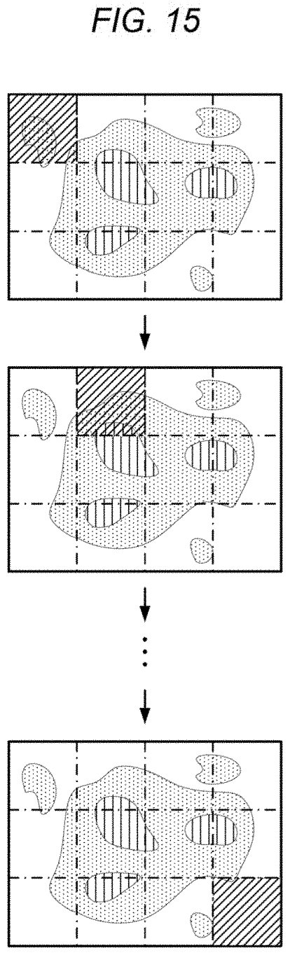

Although the diagnostic target data is chronological data on a single type of value acquired from the sensor 20 in the above-described embodiments, the diagnostic target data may have another format. For example, the diagnostic target data may be chronological data on a group of plural types of values acquired from sensors provided to a machine tool. A typical example of the diagnostic target data is chronological data on a group of voltage, current, and rotational speed. Alternatively, the diagnostic target data may be data other than chronological data. For example, the diagnostic target data may be thermal image data acquired from a thermal image sensor. In this case, as illustrated in FIG. 15, the modification target portion determiner 103 divides a thermal image into some regions and sequentially determines a hatched region as the modification target portion.

In the above-described embodiments, when the diagnostic target data contains any abnormality, the display device 30 displays the information indicating an abnormality existing in the diagnostic target data and the information indicating a portion in the diagnostic target data that corresponds to an abnormal portion. This process may be replaced with another process, which is executed when the diagnostic target data contains any abnormality. For example, a log file indicating that the diagnostic target data contains an abnormality and indicating a portion in the diagnostic target data that corresponds to an abnormal portion may be stored into the storage 110.

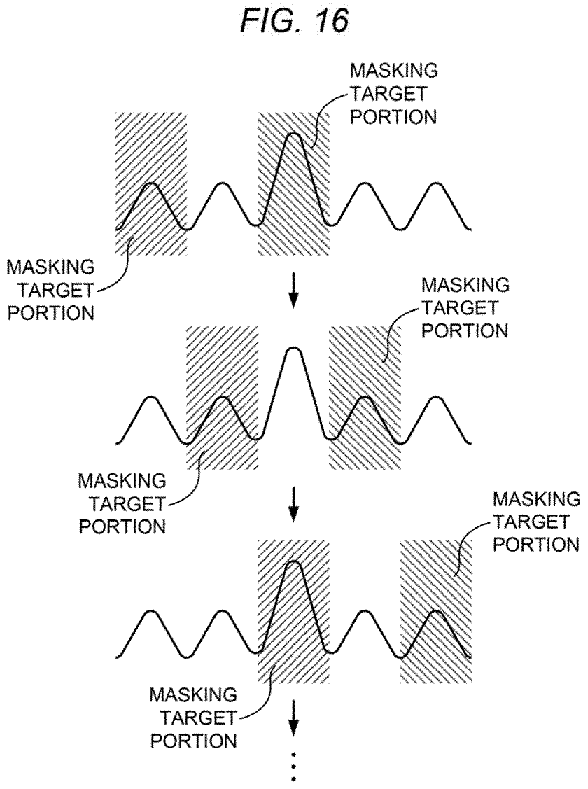

The modification target portion determiner 103 determines a single area as the modification target portion (the masking target portion in Embodiment 1, or the replacement target portion in Embodiment 2) in the above-described embodiments, as illustrated in FIGS. 4, 5, and 10, for example. Alternatively, two or more areas may be determined as the modification target portions. For example, according to a modification of Embodiment 1 as illustrated in FIG. 16, the modification target portion determiner 103 may determine two areas as the masking target portions and shift the areas by a range of one wavelength. In this case, even when the abnormal portion detector 106 detects an abnormality in the masking target portions, a single determination cannot reveal which of the two masking target portions corresponds to an abnormal portion. The first or third determination illustrated in FIG. 16 alone reveals that either one of the two masking target portions corresponds to an abnormal portion, for example. These determinations in combination can thus discover that the diagnostic target data contains an abnormal portion at the center.

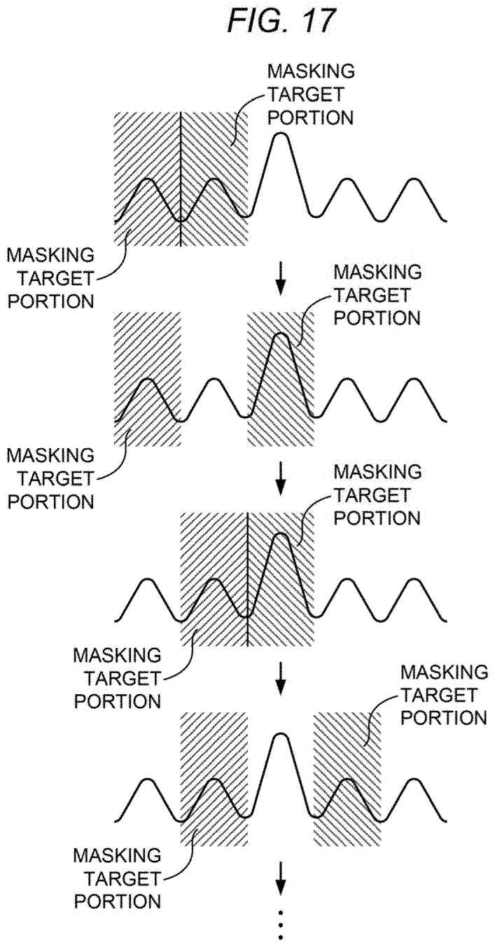

The two areas may be shifted independently from each other, or may temporarily adjoin each other. For example, as illustrated in FIG. 17, the left and the right areas adjoin each other at first, and the modification target portion determiner 103 may repeat shifting the right area and then shifting the left area to determine a modification target portion.

Alternatively, the modification target portion determiner may repeat determining any two areas as modification target portions so as to cover all the patterns of modification target portions. For example, in the case where the diagnostic target data is known in advance to contain two abnormal portions because of the features of the diagnostic target data, the detection preferably covers all the patterns of modification target portions. In the case of two abnormal portions existing in the diagnostic target data, the determination of a modification target portion as illustrated in FIG. 16, for example, may fail to simultaneously determine two abnormal portions as modification target portions. In terms of efficiency, it is preferable to specify a portion that is highly likely to be detected as an abnormal portion on the basis of the features of the diagnostic target data and preferentially determine the specified area as a modification target portion.

In the case where the number of abnormal portions is unknown, the abnormal portion detecting device 10 may first try to detect an abnormal portion while defining the number of modification target portions to be one, and may increase the number of modification target portions after every failure in detection of an abnormal portion. In this case, the detection preferably covers all the patterns of modification target portions, as in the above-described case. This configuration can enable the abnormal portion detecting device 10 to detect all the abnormal portions even when the number of abnormal portions is unknown.

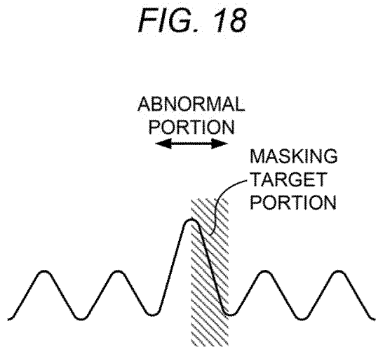

Although the modification target portion has a constant width in the above-described embodiments, the width of the modification target portion may be variable. In an exemplary case where the width of a masking target portion is narrower than the width of an abnormal portion as illustrated in FIG. 18, the abnormal portion detecting device 10 according to Embodiment 1 cannot sufficiently mask the abnormal portion and thus is highly likely to fail in detection of the abnormal portion. If the width of the modification target portion is increased after every failure in detection of an abnormal portion, the abnormal portion detecting device 10 can detect an abnormal portion regardless of the width of the abnormal portion.

The determiner 101 and the determiner 101B determine whether data contains any abnormality on the basis of the normal data model D111, which is a pre-trained model constructed through learning of normal data, in the above-described embodiments. Alternatively, the determiner 101 and the determiner 101B may determine existence of an abnormality in data by a procedure independent from the pre-trained model. For example, the determiner 101 and the determiner 101B may determine existence of an abnormality in data on the basis of whether the data satisfies the requirements defined by the manufacturer of the abnormal portion detecting device 10.

The modifier 104A determines data for use in replacement on the basis of the replacement data model D112A, which is a pre-trained model constructed through learning pairs of data corresponding to non-replacement-target portions and data corresponding to a replacement target portion, in the above-described Embodiment 2. Alternatively, the modifier 104A may determine data for use in replacement by a procedure independent from the pre-trained model. For example, the modifier 104A may derive an approximate expression representing a variation in the data on the basis of the data corresponding to non-replacement-target portions and determine data for use in replacement in accordance with the approximate expression.

Although the abnormal portion detecting device 10 includes the secondary storage unit 1004 in the hardware configuration illustrated in FIG. 6, this configuration is a mere example. The secondary storage unit 1004 may be provided outside the abnormal portion detecting device 10, and the abnormal portion detecting device 10 may be connected to the secondary storage unit 1004 via the interface 1003. In this modification, a removable medium, such as USB flash drive or memory card, may also serve as the secondary storage unit 1004.

Instead of the hardware configuration illustrated in FIG. 6, the abnormal portion detecting device 10 may be configured by a dedicated circuit including an application specific integrated circuit (ASIC) or a field programmable gate array (FPGA), for example. Alternatively, the functions of the abnormal portion detecting device 10 in the hardware configuration illustrated in FIG. 6 may be partially performed by a dedicated circuit connected to the interface 1003, for example.

The program used in the abnormal portion detecting device 10 may be stored in a non-transitory computer-readable recording medium, such as compact disc read only memory (CD-ROM), digital versatile disc (DVD), USB flash drive, memory card, or HDD, to be distributed. This program can be installed in a specific computer or general-purpose computer to cause the computer to function as the abnormal portion detecting device 10.

The program may also be stored in a storage device included in another server on the Internet and downloaded from the server into a computer.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

10, 10A, 10B Abnormal portion detecting device
20 Sensor
30 Display device
40, 40A Learning device
100, 100A, 100B Controller
101, 101B Determiner
102 Diagnostic target data transmitter
103 Modification target portion determiner
104 Modifier
105 Modified data transmitter
106 Abnormal portion detector
107 Notification executor
108B Sensitivity adjuster
110, 110A Storage
1000 Bus
1001 Processor
1002 Memory
1003 Interface
1004 Secondary storage unit
D111 Normal data model
D112A Replacement data model

1. An abnormal portion detecting device, comprising processing circuitry configured as:
a determiner to determine whether received data contains any abnormality;
a diagnostic-target-data transmitter to transmit diagnostic target data to the determiner;
a modification-target-portion determiner to determine a modification target portion in the diagnostic target data determined to contain an abnormality by the determiner;
a modifier to modify the modification target portion in the diagnostic target data and generate modified data;
a modified data transmitter to transmit the modified data to the determiner; and
an abnormal portion detector to detect the modification target portion as an abnormal portion in the diagnostic target data when the determiner determines that the modified data contains no abnormality, the modification target portion being determined by the modification-target-portion determiner.

2. The abnormal portion detecting device according to claim 1, wherein the determiner determines, on basis of a pre-trained model constructed through learning of normal data, whether the received data contains any abnormality.

3. The abnormal portion detecting device according to claim 1, wherein the modifier modifies the diagnostic target data by a masking process for excluding the modification target portion from targets of determination by the determiner.

4. The abnormal portion detecting device according to claim 1, wherein the modifier modifies the diagnostic target data by replacing the modification target portion with normal data.

5. The abnormal portion detecting device according to claim 4, wherein the modifier replaces the modification target portion with normal data on basis of a pre-trained model constructed through learning of a data pair, the data pair including data configured by removing a portion corresponding to the modification target portion from the normal data, and data on the portion corresponding to the modification target portion in the normal data.

6. The abnormal portion detecting device according to claim 1, further comprising:
a sensitivity adjuster to adjust a sensitivity of determination of an abnormality by the determiner, wherein
the sensitivity adjuster adjusts a sensitivity during determination in the modified data to be lower than a sensitivity during determination in the diagnostic target data.

7. A method of detecting an abnormal portion, the method comprising:
determining whether diagnostic target data contains any abnormality;
determining a modification target portion in the diagnostic target data, when the diagnostic target data is determined to contain an abnormality;
modifying the modification target portion in the diagnostic target data and generating modified data;
determining whether the modified data contains any abnormality; and
detecting the modification target portion in the diagnostic target data as an abnormal portion in the diagnostic target data, when the modified data is determined to contain no abnormality.

8. A non-transitory computer readable recording medium storing a program, the program causing a computer to function as:
a determiner to determine whether received data contains any abnormality;
a diagnostic-target-data transmitter to transmit diagnostic target data to the determiner;
a modification-target-portion determiner to determine a modification target portion in the diagnostic target data determined to contain an abnormality by the determiner;
a modifier to modify the modification target portion in the diagnostic target data and generate modified data;
a modified data transmitter to transmit the modified data to the determiner; and
an abnormal portion detector to detect the modification target portion as an abnormal portion in the diagnostic target data when the determiner determines that the modified data contains no abnormality, the modification target portion being determined by the modification-target-portion determiner.
